(19) United States
(12) Patent Application Publication
(10) Pub. No.: US 2014/0299230 A1
(43) Pub. Date: Oct. 9, 2014

(54) TREE TRIMMING APPARATUS WITH SAFETY BOOM

(71) Applicant: William C. Cox, III, Tabor City, NC (US)

(72) Inventor: William C. Cox, III, Tabor City, NC (US)

(21) Appl. No.: 13/858,987

(22) Filed: Apr. 9, 2013

(51) Int. Cl. A01G 23/095

(52) U.S. Cl. CPC A01G 23/095
USPC 144/24.13

(57) ABSTRACT

An airborne tree trimming apparatus for installation on a helicopter or the like is described. The apparatus is designed to prevent arcing from power lines and includes a saw assembly having a housing that is at least partially non-conductive; an internal combustion engine operatively connected to the saw assembly; a boom extension having a lower end connected to the engine, and an upper end attachable to the helicopter, at least a part of the boom extension being non-conductive; and a safety cable extending through the boom extension, at least a part of the cable being non-conductive.

This application claims the benefit of and priority to the filing date of U.S. Provisional Application Ser. No. 61/625,110, filed Apr. 17, 2012, the entire content of which is incorporated herein.

### BACKGROUND OF THE INVENTION

(1) Field of the Invention

The present invention relates generally to tree trimming apparatus comprised of an internal combustion engine powered saw suspended beneath a helicopter undercarriage by an articulated boom, which is especially suitable for trimming rights-of-way adjacent to electric power lines at a selected distance from the ground, and in particular to an apparatus of this type in which combustion of the engine fuel due to arcing from the power lines is prevented.

(2) Description of the Prior Art

Tree trimming apparatus especially suitable for trimming rights-of-way adjacent to electric power lines at a selected distance from the ground are known in the prior art including U.S. Pat. Nos. 4,554.781; 4,815,263; and 4,984,757.

A typical tree trimming apparatus includes an articulated boom for suspension beneath a helicopter undercarriage, with ten or more rotating circular saw blades mounted in coplanar, closely spaced, tandem relationship on the boom. The circular saw blades are powered by an internal combustion engine mounted on a drive, or engine section assembly of the boom. The circular saw blades extend about ten inches out from the boom structure and thus permit the cutting of large tree branches which are six to eight inches or more in diameter, as well as smaller woody growth.

The boom-mounted circular saw blades rotate in a vertical plane when operational, with all blades oriented outwardly of the supporting boom. The blades each rotate on a separate shaft which is cantilever-mounted in the boom, such that the outside surfaces of the blades are located in a common plane. Accordingly, as the helicopter passes along the edge of a row of trees to be cut, the circular saw blades are always oriented on the tree side of the boom and are adapted to engage and cut the branches through. The severed branches then fall away on the boom side of the tree trimming apparatus.

The articulated boom may be constructed of multiple sections, each section carrying one or more rotatable, belt-driven circular saw blades and the saw-carrying boom sections may be reversed top to bottom on the ground, in order to move the blades to the desired cutting side of the helicopter. For example, ten circular saw blades may be mounted on a saw which typically has a length of about 25 feet. The saw is attached by a boom made up of multiple tubular sections totally about 80-100 feet in length. In the absence of a significant tail-wind, the usual operational practice is to fly the helicopter along one side of a power line, trimming the tree branches and woody growth at a selected height for several miles and return in the opposite direction to cut the branches and woody growth on the opposite side, without shifting the circular saw blades from right to left.

The engine used to drive the blades should be capable of operating the blades at approximately 2300 to 2500 rpm. The inertia of the circular saw blades is a very significant factor in the cutting efficiency thereof, and due to the relatively great total weight and large blade diameter of these tandem-mounted blades, this factor aids in cutting tree branches of both small and large diameter.

It should be noted that the pivotal mounting of the articulated boom in the airborne tree trimming apparatus about a transverse axis which is substantially perpendicular to the direction of lotion of the helicopter, not only aids in take-off and landing of the apparatus, but also permits the apparatus to yield slightly to the rear when encountering numerous or large branches during airborne operation. Thus, while the helicopter speed may be five to ten feet per second, the forward cutting speed of the circular saw blades through very large branches along a flight path beneath the helicopter may be somewhat less than this speed. The greater the average speed which is attainable for the helicopter at effective cutting rates, the more cost-effective the clearing operation will be.

The apparatus permits rapid and accurate trimming of trees adjacent to electric utility and other rights-of-way in a safe and efficient manner. The circular saw blades are designed to complement each other and to cause one blade to continue a cutting which is begun by an adjacent blade, where necessary in cutting large limbs.

In use, an articulated boom carrying the tandem-mounted circular saw blades and attached to a helicopter will slope slightly rearwardly from the attachment point at the helicopter and from the articulated joint along a flight path beneath the helicopter, so that very small branches and woody growth cannot pass between any two adjacent blades without being cut. Take-off and landing with the apparatus is a simple matter for a qualified helicopter pilot due to the front-to-rear articulation of the operating boom with respect to the boom extension, permitting the apparatus to be laid out on a pair of ground-supported cradle supports beneath the helicopter at take-off or landing.

In prior art apparatus, the boom is typically constructed of aluminum or steel tubing with a steel cable extending through the center bore of the boom tubing. The upper end of the boom cable is attached to the helicopter via a releasable coupling enabling quick release of the boom and saw in the event of an emergency, e.g., if the saw becomes entangled in the trees. For example, the upper end of the cable may be looped around a keeper that is pivotally detachable from the cable.

An additional safety concern is that the boom may contact, or come within arcing distance of, the power lines. It is possible that the boom can come too close to the power lines due to the proximity of the helicopter or if the boom is separated from the helicopter during an emergency release. In the event that the boom contacts or comes close to the power lines at the same time that the saw contacts or comes close to trees or the ground, a circuit can be completed causing an explosion of fuel in the engine and resulting fire in the surrounding area. Of possibly even greater consequence is the danger that the power lines may short out and break, resulting in considerable cost and loss of power to a large geographical area until the lines are repaired.

### SUMMARY OF THE INVENTION

The present invention addresses this concern by positioning a non-conductive boom section between the upper part of the boom that might potentially come too close to the power lines and the engine fuel tank, with the section being of sufficient length to prevent arcing across the section. The non-conductive section can be the entire boom or a section of the boom. Alternatively, the engine housing can be non-conductive. In addition, the cable, or a part of the cable, must be non-conductive.

Generally, the airborne tree trimming apparatus described herein is installed on a helicopter or the like. The apparatus includes a saw assembly; an internal combustion engine operatively connected to the saw assembly; a boom extension having a lower end connected to the engine, and an upper end attachable to the helicopter, at least a part of the boom extension being non-conductive; and a safety cable extending through the boom extension. The engine includes a fuel tank and preferably a housing that is at least partially non-conductive.

The boom extension includes at least one tubular non-conductive section or may be made for a single non-conductive tubular material, such as fiberglass, or a plurality of non-conductive tubular sections. The safety cable may be entirely of a non-conductive material, such as nylon, or at a part of the safety cable being non-conductive. The safety cable may include connectors to the helicopter and to the internal combustion engine. The upper end of the safety cable may be looped to extend around a releasable keeper. Several means of attaching conventional boom extensions and safety cables to helicopters are known in the prior art and are suitable for use in the present invention.

### BRIEF DESCRIPTION OF THE DRAWINGS

FIG. 1 is a perspective view of a helicopter with articulated boom and saw.

FIG. 2 is a sectional side view of the upper end of the boom.

FIG. 3 is a sectional side view of the boom with non-conductive section.

FIG. 4 is a sectional side view of the lower end of the boom attached to the saw engine housing.

### DETAILED DESCRIPTION OF THE INVENTION

In the following description, terms such as horizontal, upright, vertical, above, below, beneath, and the like, are used solely for the purpose of clarity in illustrating the invention, and should not be taken as words of limitation. The drawings are for the purpose of illustrating the invention and are not intended to be to scale.

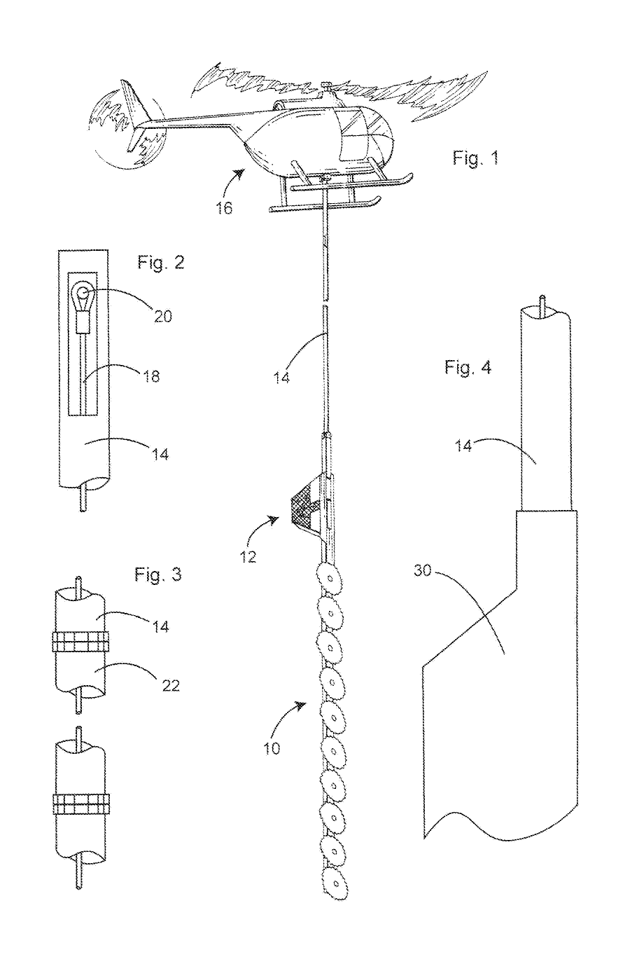

As shown in FIG. 1, the overall apparatus of the invention is comprised of a saw, generally 10, with an internal combustion engine and fuel tank 12 attached by a boom extension 14 to a helicopter 16.

FIG. 2 illustrates the top section of boom extension 14 with an opening to show cable 18 attached to a keeper 20. In the invention, boom extension 14 is constructed of a non-conductive material, e.g., tubular fiberglass, while cable 18 is made of a non-conductive material, e.g., nylon.

FIG. 3 illustrates an alternative means to insulate the engine fuel tank in which a non-conductive boom section 22 is secured between upper and lower sections of boom extension 14. The length of section 22 is greater than the arcing distance of the voltage likely to be encountered. While shows as intermediate two conductive boom sections, the non-conductive section may instead be used as the section closest to the top or bottom of the boom.

FIG. 4 illustrates another means of preventing arcing by using an engine and fuel tank enclosure 30 formed of a non-conductive material, e.g., molded fiberglass.

After reading this description, other means for creating a non-conductive gap between the upper end of the boom and the engine fuel tank will become apparent to one skilled in the art. It should be understood that these and other modifications and improvements have been deleted herein for the sake of conciseness and readability but are properly within the scope of the following claims.

What is claimed is:

1. An airborne tree trimming apparatus for installation on a helicopter or the like comprising:
a) a saw assembly;
b) an internal combustion engine operatively connected to said saw assembly; and
c) a boom extension having a lower end connected to said engine, and an upper end attachable to said helicopter, at least a part of said boom extension being non-conductive.

2. The apparatus of claim 1, further including a safety cable extending through said boom extension, at least a part of said cable being non-conductive.

3. The apparatus of claim 1, wherein said engine includes a housing that is at least partly non-conductive.

4. The apparatus of claim 3, wherein said boom extension lower end is connected to said engine housing.

5. The apparatus of claim 1, wherein said saw assembly is comprised of a plurality of circular saws aligned in a common vertical plane.

6. The apparatus of claim 1, wherein said boom extension includes at least one tubular non-conductive section.

7. The apparatus of claim 1, wherein said boom extension is made of tubular fiberglass.

8. An airborne tree trimming apparatus for installation on a helicopter or the like comprising:
a) a saw assembly;
an internal combustion engine operatively connected to said saw assembly;
c) a boom extension having a lower end connected to said engine, and an upper end attachable to said helicopter, at least a part of said boom extension being non-conductive; and
d) a safety cable extending through said boom extension, at least a part of said cable being non-conductive.

9. The apparatus of claim 8, wherein said engine includes a housing that is at least partly non-conductive.

10. The apparatus of claim 9, wherein said boom extension lower end is connected to said engine housing.

11. The apparatus of claim 8, wherein said saw assembly is comprised of a plurality of circular saws aligned in a common vertical plane.

12. The apparatus of claim 8, wherein said boom extension includes at least one tubular non-conductive section.

13. The apparatus of claim 8, wherein said boom extension is made of tubular fiberglass.

14. An airborne tree trimming apparatus for installation on a helicopter or the like comprising:
a) a saw assembly having a housing that is at least partially non-conductive;
b) an internal combustion engine operatively connected to said saw assembly;
c) a boom extension having a lower end connected to said engine, and an upper end attachable to said helicopter at least a part of said boom extension being non-conductive; and
d) a safety cable extending through said boom extension, at least a part of said cable being non-conductive.

15. The apparatus of claim 14, wherein said boom extension lower end is connected to said engine housing.

16. The apparatus of claim 14, wherein said saw assembly is comprised of a plurality of circular saws aligned in a common vertical plane.

17. The apparatus of claim 14, wherein said boom extension includes at least one tubular non-conductive section.

18. The apparatus of claim 14, wherein said boom extension is made of tubular fiberglass.

19. The apparatus of claim 14, wherein said safety cable is made of nylon.

20. The apparatus of claim 14, wherein the upper end of said safety cable is looped.
